(19) United States
(12) Patent Application Publication
(10) Pub. No.: US 2016/0127807 A1
(43) Pub. Date: May 5, 2016

(54) DYNAMICALLY DETERMINED AUDIOVISUAL CONTENT GUIDEBOOK

(71) Applicant: EchoStar Technologies, L.L.C., Englewood, CO (US)

(72) Inventors: Mark Templeman, Parker, CO (US); Yunfeng Yang, Aurora, CO (US)

(21) Appl. No.: 14/527,178

(22) Filed: Oct. 29, 2014

(51) Int. Cl. H04N 21/8549; H04N 21/439; H04N 21/44; H04N 21/472

(52) U.S. Cl. CPC H04N 21/8549; H04N 21/47202; H04N 21/4394; H04N 21/44008

(57) ABSTRACT

What is disclosed is a dynamically determined audiovisual content Guidebook that provides a visual summary of an audiovisual content event such as a recorded movie, program, sports event, or documentary and is made up of a subset of content images that together best communicates a summary of the content. Once created, a viewer can then look at the Guidebook to understand the summary of the content event and to determine whether to watch the content event now, later, or to delete it.

### BACKGROUND

1. Technical Field

The present disclosure relates to the field of audiovisual content presentation, and in particular, to systems and methods used to dynamically create a subset of the images found within an audiovisual content event in order to communicate a summary of the story, characters, or other attributes of the audiovisual content event.

2. Description of the Related Art

Audiovisual content providers frequently provide summaries and synopses for different kinds of audiovisual content including movies, documentaries, television series, sports events, and musicals. Often, third parties review commercial audiovisual content and write summaries that describe the actors, characters, plot summary, key scenes and events, filming locations, and other content information that a potential viewer may want to know in order to determine whether to watch the movie, documentary, etc. These written summaries, in various lengths, are found in electronic programming guides as provided by Direct TV™, printed television guides such as TV Guide™, and in online sources such as IMDB™.

Audiovisual content distributors frequently put bookmark information into distributed content. For example, movies distributed on DVDs are frequently divided into chapters, where each chapter will have a description and may include a thumbnail image. Online content providers, for example, Netflix™, will show thumbnails of images along a timeline to help the viewer identify a specific location to resume playing the movie.

### BRIEF SUMMARY

A dynamically determined audiovisual content Guidebook allows a viewer to see a visual summary of a recorded audiovisual content event, such as a movie, program, sports event, documentary, or other that includes a subset of content event images that together best communicate the story as conveyed in the content. The viewer can then look at the Guidebook as a summary of the content to determine what to do with the content event, for example, to either watch it now or later, to watch part of it, or to delete it.

The visual summary is in the form of a sequence of images found within the content that are selected to convey meaningful information to the viewer. For example, for a movie these images may be selected to show the actors, the characters portrayed, significant events that happen to the characters, the progression of the plot, and locations where significant plot events take place. For sporting event such as a football game, the images may be selected to show the players, kickoffs, turnovers, punts, major penalties, and scoring plays.

A Guidebook is dynamically created by analyzing received audiovisual content, individual viewer Guidebook preferences, and additional information about the video content (for example, meta-data). Analysis includes video and audio recognition to determine which images should be selected to include in the Guidebook. For example, scenes depicting explosions, actors entering or leaving the scene, the first image displayed after an extended period of black images, the first image displayed after an extended period of silence, and so on, are all indicators of a potential image to be captured for the Guidebook.

A Guidebook may also be created, or edited, by a user by viewing the audiovisual content event and selecting those pictures that should be included in its associated Guidebook. This may be done, for example, by a special button on a set-top box remote control that will store the currently displayed image as a page in the Guidebook. While editing a Guidebook this way, another button on the remote control may be used to select and remove a Guidebook page, or to enter and/or edit text that is associated with a Guidebook page.

Once the Guidebook is created, it can be stored separately from the recorded audiovisual content, or embedded within the content. Viewers use the Guidebook in a number of different ways, for example, by viewing the Guidebook as a layout of a series of still images, or by playing the images in sequence as a “mini-movie.” In one embodiment, viewers can select a particular image and the audiovisual content will be presented to the viewer starting at the point where the image was located in the audiovisual content event.

### BRIEF DESCRIPTION OF THE SEVERAL VIEWS OF THE DRAWINGS

FIG. 1 shows one embodiment of a Guidebook system and a user interacting with and creating a Guidebook.

FIG. 2 shows an example embodiment of selecting frames in audiovisual content to create a Guidebook.

FIG. 3A shows an example flow diagram for dynamically authoring a Guidebook.

FIG. 3B shows an example flow diagram for viewing a Guidebook.

FIG. 3C shows an example flow diagram for viewing audiovisual content with an embedded Guidebook.

FIG. 4 is a schematic diagram of a computing environment in which systems and methods of dynamically creating, editing, and displaying a Guidebook are implemented.

### DETAILED DESCRIPTION

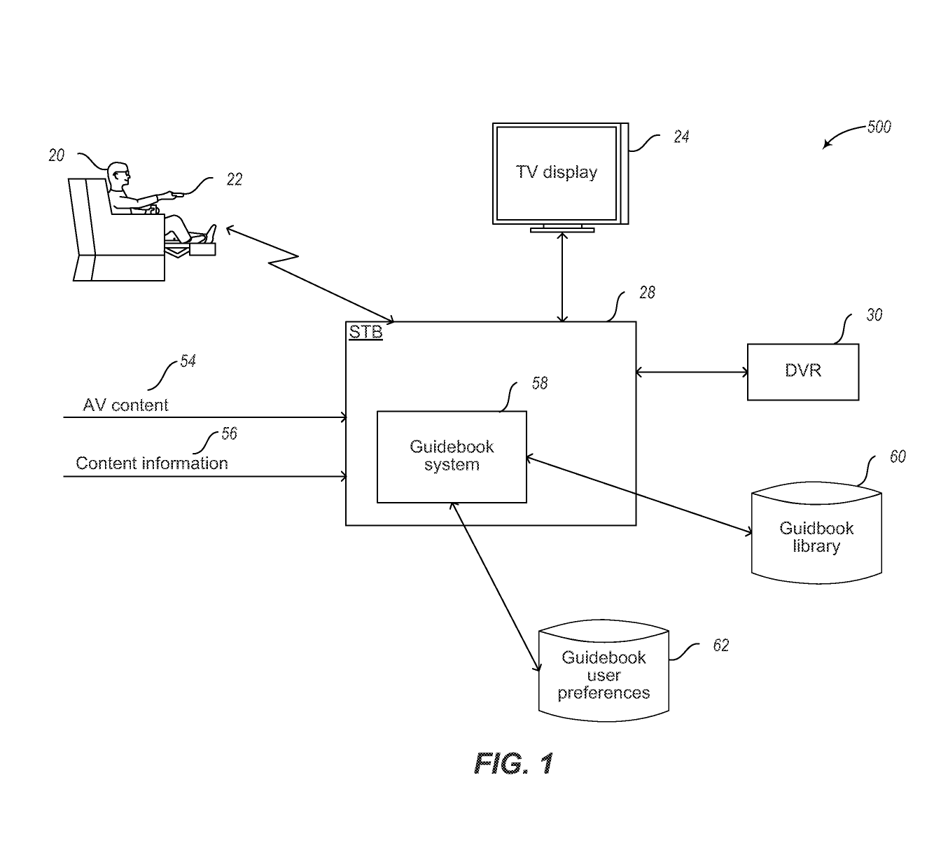

FIG. 1 shows diagram 500 which is one embodiment of the user environment where a viewer 20 interacts with the Guidebook system 58 contained within a set-top box 28. The viewer 20 may interact with the Guidebook system 58 using a remote control 22, or may interact using some other input such as a voice-recognition system or with visual gestures such as a hand wave that are detected and interpreted by an input device (not-shown) connected to set-top box 28.

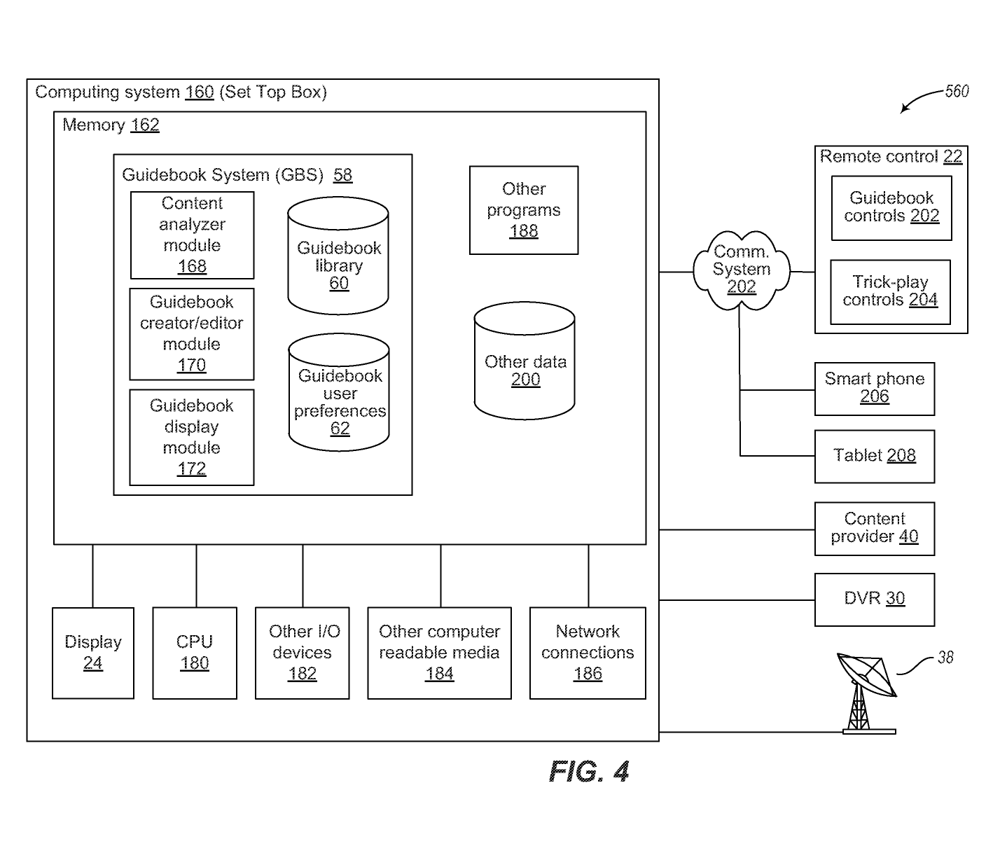

In one embodiment, a content provider 40 (FIG. 4), provides audiovisual content 54 to set top box 28, for example, through a cable or satellite system 38 (FIG. 4). The set-top box 28 acts as a receiving device to receive audiovisual content 54 and display the received content 54 on a display device 24. The set-top box 28 may also store audiovisual content by recording the content onto a digital video recorder (DVR) 30, and then allow the viewer 20 to subsequently review and select stored audiovisual content for display on display device 24. In some embodiments a digital video recorder 30 may be contained within the set-top box 28.

The ability to record a large amount of audiovisual content events, for example, movies, television series, musical performances, sports events, news events, financial reports and the like give a viewer 20 a vast amount of audiovisual content to consume. Over a short period of time, in some cases only a few days, the number of recorded audiovisual events could be in the hundreds or even thousands. Although the viewer 20 may scroll through recorded programs and look at some program information such as program title, the viewer 20 has limited information available to understand the contents of the recorded program in enough depth to determine whether or not to view the program.

With the Guidebook system 58, a viewer 20 is able, for example, to dynamically create Guidebooks for all recorded movies on set-top box 28, which then become visual summaries (relevant to the viewer 20) of the movies that the viewer 20 can use to determine whether to watch that recorded movie. The viewer 20 is able to view a Guidebook on a number of different devices. For example, the viewer 20 could use remote control 22 to select and display a Guidebook for a recorded movie that would display on the display device 24 a series of pictures captured from the movie that gives a summary that may include when one of the viewer's favorite actors enters or leaves a scene. The viewer 20 could use this Guidebook to determine whether or not to watch that movie in full. The viewer 20, in other embodiments, can also access the Guidebook via a smart phone 206 or tablet 208. A viewer 20 may view a Guidebook in different ways including, for example, viewing the pictures presented in a slideshow sequence running at varying speeds, presented as individual pictures laid out on a screen, or presented as individual pictures than can be viewed in sequence.

A viewer 20 may, for example, set Guidebook user preferences 62 to dynamically create a Guidebook for an audiovisual recorded event that is identified as a movie. This way, if a movie is identified, the Guidebook system 58 captures a Guidebook summary of the story, main characters, plot lines, and/or the story resolution to allow the viewer to easily determine whether to watch the movie now, to save it for later or to delete it altogether. Different preferences may be used if the recorded event is a sport event. In this example, scoring events, substitutions of key players, and crowd reactions will be used to create the Guidebook summary of the audiovisual event. This way, Guidebook user preference database 62 holds information for analyzing particular types of audiovisual content and identifying important attributes of the content for a particular viewer 20 to dynamically create a Guidebook optimized for how that particular viewer 20 best understands a visual summary of the recorded content event.

In one or more embodiments, the Guidebook system 58 receives audiovisual content coming from a number of different sources, including a content provider 40 (FIG. 4), a digital video recorder 30, or other device such as a DVD, computer, tablet 208, smart phone 206, video camera, and the like. The source may also include a file downloaded from the Internet, or other streaming media source that is captured. The Guidebook system 58 dynamically analyzes the incoming content, including visual, audio, and other information such as metadata, closed-captioning information, and the like, to create an associated Guidebook for the received audiovisual content. In one or more embodiments, the Guidebook may then be stored in a Guidebook library 60 where the Guidebook can later be retrieved for review by the viewer 20. In some embodiments, the Guidebook library 60 may be contained within the set-top box 28, may be stored in a separate component connected to the set-top box 28, or be stored within a data store on a local network, a wide area network, or in the cloud.

The Guidebook system 58 may also use information embedded as metadata and text data within the audiovisual content 54 stream as information used to create a Guidebook. This information includes but is not limited to, closed caption information, subtitles, genre information, channel information, and program titles. In some embodiments, other content information 56 related to the audiovisual content 54 can be received from a data channel or other communication data stream that is separate from the stream the audiovisual content is received on.

In one or more embodiments, one or more of the preference variables stored in the Guidebook user preferences database 62 may have to do with the various types, classifications or categories of the audiovisual content 54 that is received. For example, types of audiovisual content events may include but are not limited to movies, news programs, documentaries, sports events, documentaries, and musicals that may cause the Guidebook system 58 to interpret similar visual or audio cues in different ways.

In addition to metadata embedded within the audiovisual content 54, other information analyzed by the Guidebook system 58 include visual cues and audio cues that are extracted from the content. The user preferences database 62 will provide information used by the system to identify pages to add to the Guidebook depending on the viewer 20 and the audiovisual content type.

Examples of visual cues include but are not limited to contrast changes, for example, a frame going from a black display to a non-black display, when a frame changes its content entirely (which may be indicated, for example, by an I-frame in an MPEG-encoded stream), changes in a dominant color on the screen or changes in background scenery. The application of visual recognition techniques may also be used to identify individuals and objects depicted in a frame. For example, without limitation, to determine when any individual (e.g., an actor or a sports player) enters into the frame or when that individual leaves the frame, the appearance of a referee (for example, in a striped uniform) with hands in the air signaling a score, the identification of a raised weapon in the hand of an actor, the appearance of background crowd standing up (such as after a goal scored), and the like.

Examples of audio cues include changes in the audio background, for example, silence followed by a “bang” before a shot is fired, the roar of the crowd that indicates a goal has been scored, the loudest magnitude sound, the lowest magnitude sound (no sound), building music that gets louder such as a heartbeat that slowly grows to a pounding sound, music that transitions from a background orchestra to the single voice of a performer, the sound of a new voice, or the sound of a voice that has been added to a conversation, laughter of a crowd, a scream, a spoken word or set of words such as “help me,” or the name of a character, and the like.

Similar audio cues may be interpreted very differently based on the type of audiovisual content event. For example, silence in an audio track may indicate a lull in a sporting event that would not indicate any impending descriptive image to capture that summarizes the sporting event. However, if the content is a musical, the silence may indicate an impending image that would be very important to the summary of the musical, such as the beginning of a new act or of a solo performance.

Examples of technical cues may include compression information, for example, under MPEG compression as mentioned above, when an I-frame versus a T-frame or B-frame is indicated in the audiovisual content 54.

Content information 56 may also contain additional information that relates to the audiovisual content event overall, or relate to specific segments within the content. For example, content information 56 may include the name of sports teams for the audiovisual sporting event which may then be used to recognize the team name as it is displayed visually on a score block (to be identified by visual recognition techniques) or the team name as it is spoken by the announcer, such as “the Broncos have just scored.” For movies, content information 56 may include a list of characters and the actors playing them, or a list of locations where the movie had been filmed. For series, it may include a list of guest stars that can be visually recognized by the Guidebook system 58 when those guest stars walk into the frame.

Other examples may include viewer-specific attributes found in the Guidebook user preferences database 62 such as when a particular tone is played, a favorite actor walks into the frame, a particular voiceover is heard, a particular building or place is shown and the like.

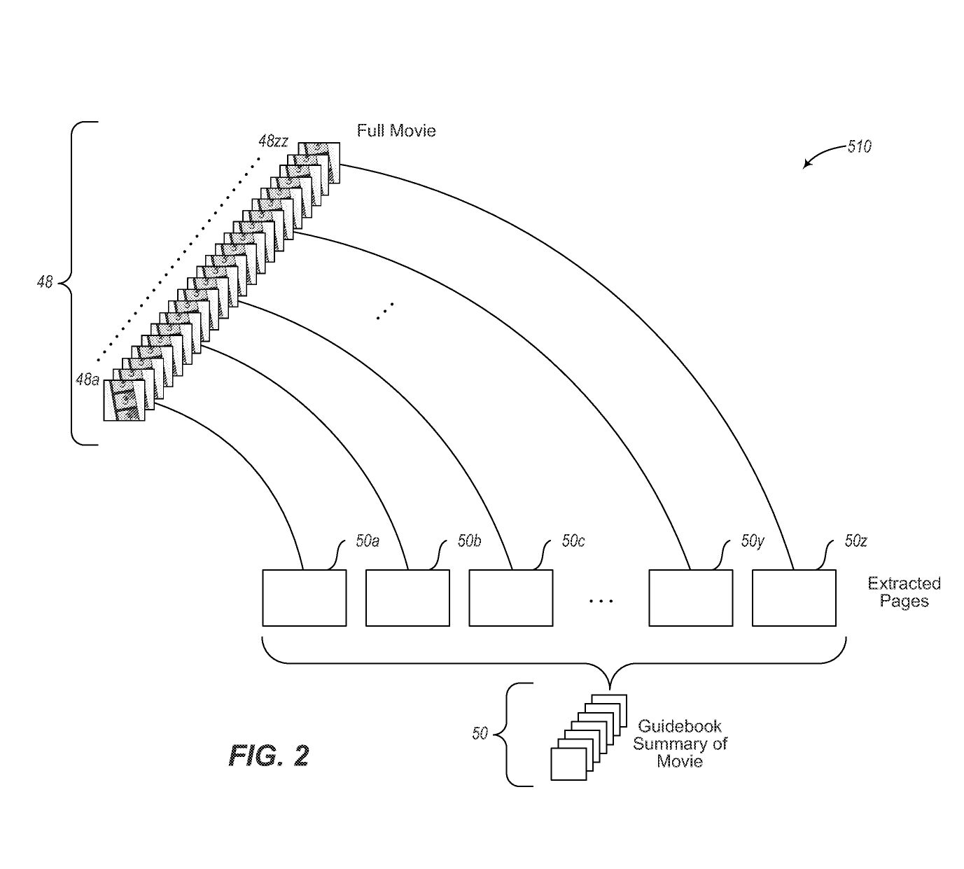

FIG. 2 shows diagram 510 describing one embodiment of how a Guidebook may be created. In this example, a full movie 48, that represents a recorded audiovisual content event for which a Guidebook is to be created, is represented by a series of individual frames 48a-48zz. Each of these frames is displayed, along with any associated audio track, on display 24 when a viewer 20 views the full movie 48.

A Guidebook 50 is created for the movie 48 by extracting a subset of frames 50a-50z from the series of individual movie frames 48a-48zz, using criteria for determining a relevant picture frame from the movie frames 48a-48zz with examples as described above. In one or more embodiments, for individual frames 48a-48zz that are compressed, for example, in MPEG format, the extracted frames 50a-50z will need to be decompressed so they can be presented as individual images to the viewer 20. The resulting extracted frames 50a-50z form a Guidebook summary of the movie 50.

In this example, during the Guidebook creation process, each of the extracted frames 50a-50z will be dynamically selected, including using criteria found in the Guidebook user preferences database 62, such that when the Guidebook 50 is viewed by the viewer 20, the viewer will have a sufficient understanding of the plot of the movie to determine whether to view the movie now, view it later, or delete it entirely.

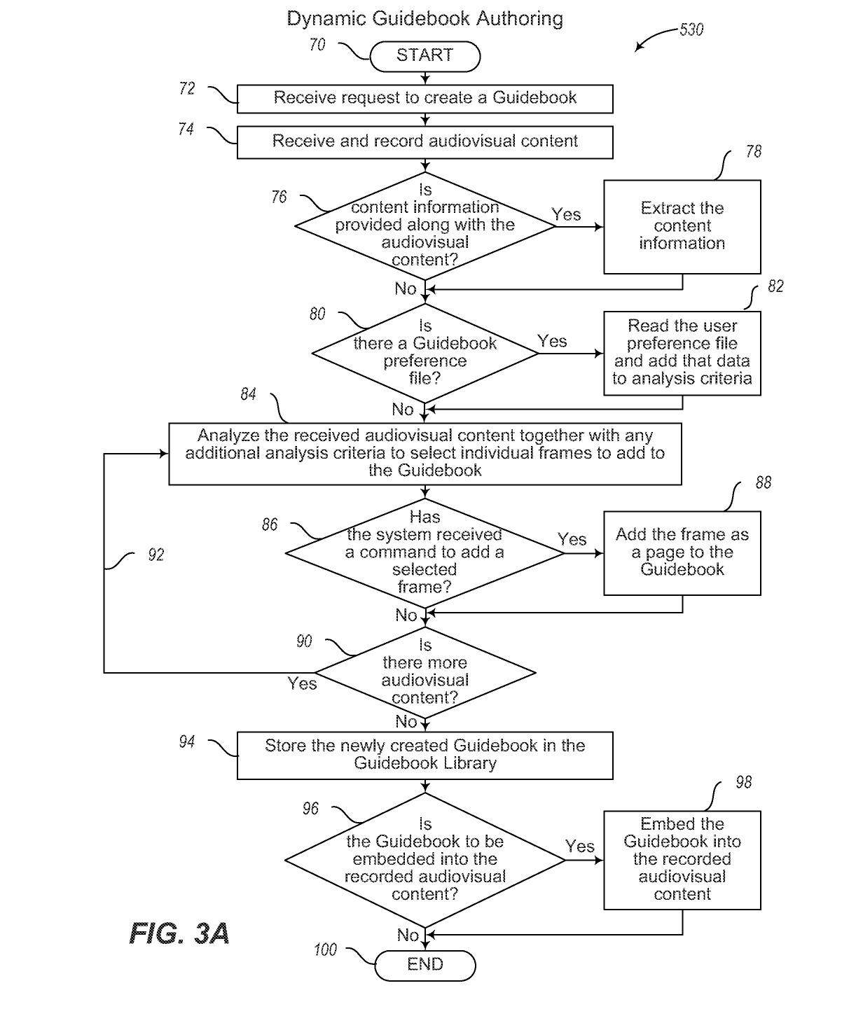

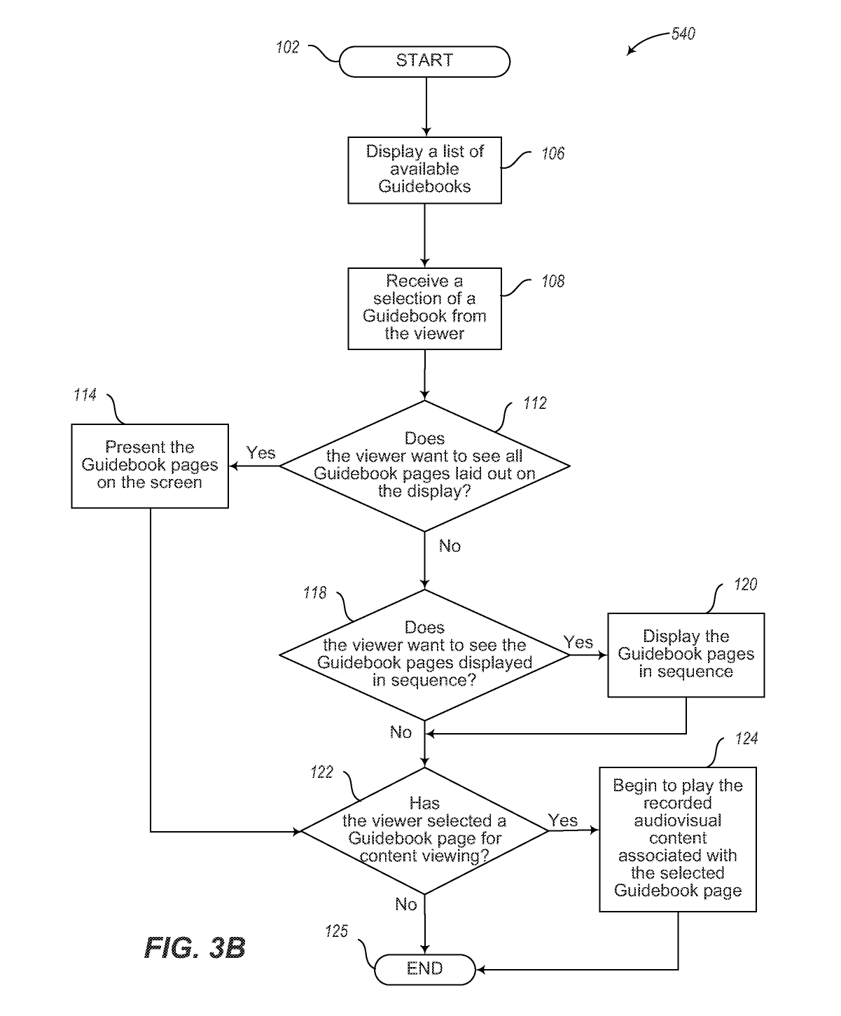

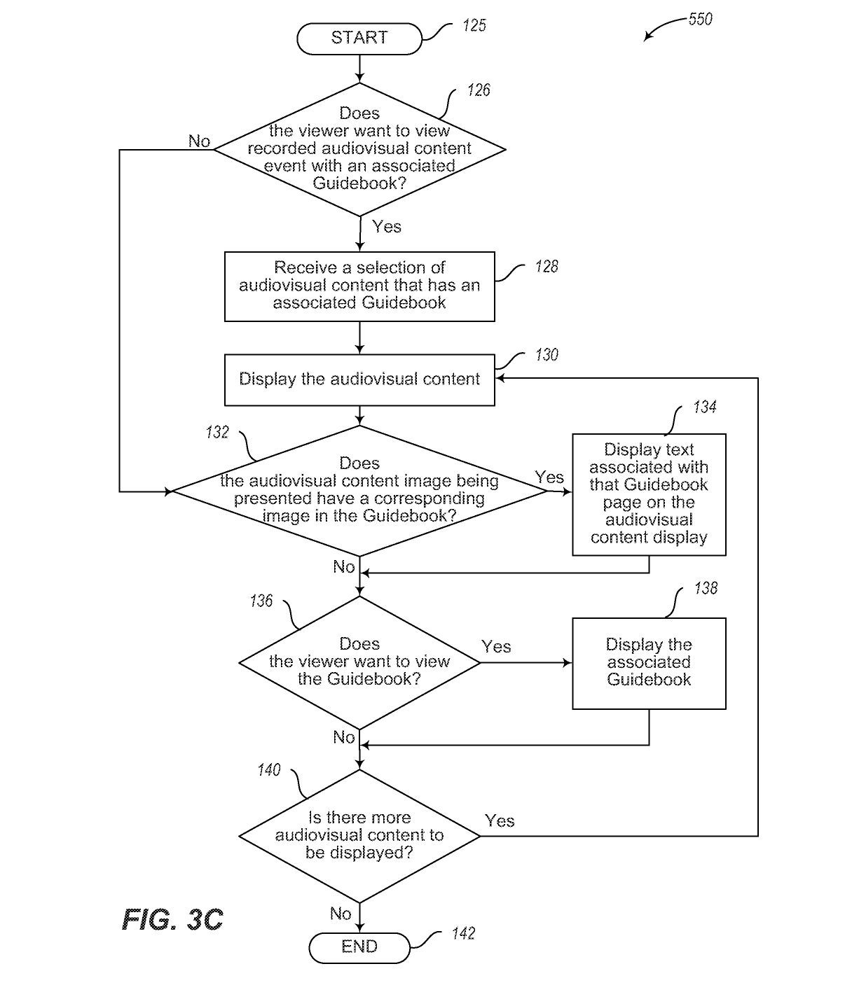

FIG. 3A shows diagram 530 of one embodiment of the method for dynamic Guidebook authoring. The method begins at step 70. The first step is to receive a request to create a Guidebook 72. This request may come from several different sources such as a specific request from a viewer 20 sending a specific command to create a Guidebook for a selected recorded audiovisual content event using a remote control 22. It may also come from an entry in the Guidebook user preferences database 62 used to identify specific types of audiovisual content 54 for which a Guidebook should be dynamically created, for example, for any new mystery movies, or if new Broncos games are recorded by the set-top box 28. It may also come via communication with a digital video recorder 30 to create a Guidebook for recorded content for which there is no existing Guidebook either in the viewer's 20 environment or elsewhere available via the Internet. These are non-limiting examples of how Guidebook creation may be requested.

At the next step, receive and record audiovisual content 74, the audiovisual content 54 may be received from a number of different sources. These sources may include a head-end, a satellite feed, audiovisual content files or audiovisual data streams from the Internet, an external device such as a digital video recorder 30, a digital video disc player, or other source of audiovisual content. The received audiovisual content 54 may then be stored in a number of different locations, including on the set-top box 28, on a digital video recorder 30, or other storage medium accessible by the set-top box 28, such as cloud-based storage accessible via the Internet.

At the next step, content information provided along with the audiovisual content 76, determines whether content information is provided and available for the Guidebook system 58 to use. If so, then at step 78 extract the content information will gather this content information and use it in conjunction with the analysis criteria used to analyze the content to determine the Guidebook pages 50a-50z to select for that content. Content information 56 includes, for example, information in the form of text, metadata, data within the audiovisual content stream, as well as data broadcast in a separate data channel related to the audiovisual content stream. Content information 56 data can include, for example, information about the entire production, for example, producer, studio, editing, and writing information; time-stamp date when the content was released, genre information, ratings information, and other production related information. The information can also include content-based information such as number of scenes, character names, plot overview, scene index information, and the like. In addition, content information 56 can include information about segments of audiovisual content, for example, detailed scene information such as the characters that appear in the scene, and the location where the scene was shot. If there is no content information provided along with the audiovisual content, then the method continues.

The next step 80 determines if there is a Guidebook preference file. If so, at step 82 the system reads the Guidebook user preference file 62 and adds that data to the analysis criteria. In some embodiments, there is a default value for entries in the Guidebook preference file 62 that will indicate default values for performing dynamic Guidebook authoring. In other embodiments, the Guidebook authoring system itself contains default values for creating Guidebook pages. For example, one default value may be to create a Guidebook page whenever there is a scene change in a movie. If there is no Guidebook preference file, the method continues.

At step 84, the received audiovisual content is analyzed together with any analysis criteria to select individual frames to add as pages to the Guidebook. As discussed above, the Guidebook system 58, in some embodiments, uses visual recognition techniques and audio recognition techniques to analyze the audiovisual content 54 and then applies the additional analysis criteria from above to determine the specific frames 48a-48zz to select to create the pages 50a-50z to include in the Guidebook 50 to summarize that content event.

The next step determines whether the Guidebook system has received a command to add a selected frame 86 to the Guidebook. In some embodiments, this request may have come from the viewer 20 who has chosen to add an additional frame not identified by the dynamic Guidebook authoring system. For example, this request may come from a remote control that is used to select the specific frame to be added. If so, at the next step the system will add the frame as a page to the Guidebook 88. In some embodiments, this request to add a selected frame may be done during the Guidebook creation process and in other embodiments may be done as part of an editing process to an existing Guidebook.

The next step, is there is more audiovisual content to be processed 90, determines if all of the audiovisual content event has been processed. For example, if all of the frames in the recorded audiovisual content have been processed, including associated audio and content information, it is determined whether additional Guidebook pages 50a-50z should be added to the Guidebook 50. If there is additional audiovisual content to be processed, the method flow goes back to step 84. If not, the method continues.

The next step, store the newly created Guidebook in the Guidebook library 94, stores a copy of the newly created Guidebook in the Guidebook library 60 for future viewing by the viewer 20 to determine, for example, whether to watch the recorded audiovisual content event from which the Guidebook is generated. At this step, all of the identified pages, including any additional text or other information associated with the pages, is assembled into a Guidebook 50 and associated with the recorded audiovisual content event from which it was derived. In some embodiments, the Guidebook 50 may be stored on a local storage device in a local Guidebook library 60; in other embodiments the Guidebook 50 may be stored on a device that is accessible to but not located near the viewer 20.

The next step determines whether the Guidebook is to be embedded into the recorded audiovisual content 96. In some embodiments, the Guidebook 50 may be combined with its associated recorded audiovisual content event. This allows, for example, a user to send a single file that has both the audiovisual content and Guidebook embedded, and to not have to bother with two separate files. If so, at step 98 the system embeds the Guidebook into the recorded audiovisual content.

The dynamic Guidebook authoring method then ends at step 100.

FIG. 3B shows diagram 540 of one embodiment of a method for selecting and playing a Guidebook. This method shows one embodiment of selecting and viewing a Guidebook for display. At step 102, the method starts. The first step is to display a list of available Guidebooks 106. In various embodiments, these Guidebooks will be in a Guidebook library 60 on a set-top box 28 or in a storage device such as a digital video recorder 30 associated with the set-top box 21i8, or on another location either within the viewer's 20 location or external to the location, for example, accessible over the Internet. In some embodiments, the Guidebook will be shown on display device 24; in other embodiments, the list of Guidebooks may be shown on a smartphone 206, table 208, or other display device. The list of Guidebooks may be either standalone Guidebooks or Guidebooks embedded into recorded audiovisual content events.

The next step is to receive a selection of a Guidebook from the viewer 108. In one or more embodiments, a viewer will use commands on remote control 22 to scroll through and identify and select a Guidebook from a list of available Guidebooks from the Guidebook library 60 displayed on display device 24. In other embodiments, the viewer 20 may use a smart phone 206, tablet 208 or other device and select a Guidebook displayed on that device. In some instances, this selection may be made via a touch screen interface.

At the next step, it is determined if the viewer wants to see all Guidebook pages laid out on the display 112. This is one non-limiting example of how a viewer may wish to view the pages of a Guidebook in order to understand the story, characters, or ending of a recorded audiovisual content event. This example presents one or more pages per screen on the display device 24 and allows the user to scroll around the pages as if they were laid flat on a surface. If the viewer 20 wishes to view the Guidebook pages this way, step 114 presents the Guidebook pages on the screen, which allows viewer 20 to see either all or a large number of the pages 50a . . . 50z. After this, the method goes to step 122.

Otherwise, at the next step it is determined whether the viewer wishes to see the Guidebook pages displayed in sequence 118. If so, in some embodiments, the viewer wishes to see the pages 50a-50z of the Guidebook presented in a “movie-type” format where they are showed in sequence. If so, then the Guidebook pages in are displayed in sequence 120. Unlike the flat presentation of the pages 50a . . . 50z as described above, here the user can see a presentation as a movie or a slideshow of the pages 50a . . . 50z. In some examples, the viewer 20 may want the pages to be displayed at a certain rate, for example, one page every half second. In other examples, the user may choose to advance, by using a remote control 22 or other input/output devices 182 such as a mouse or touchpad, the Guidebook to display the next Guidebook page. Similarly, another command may be used to “back up” and display the previous Guidebook page.

At the next step, it is determined whether the viewer selected a Guidebook page for content viewing 122. In one or more embodiments, this step allows a viewer 20 to select a Guidebook page and to have the recorded audiovisual content event associated with that page to begin to play from the frame of the content represented by that Guidebook page. If so, then at step 124 the system will begin to play the recorded audiovisual content associated with the selected Guidebook page.

When the viewer 20 has finished viewing the Guidebook pages, or viewing the content that was initiated by selecting a Guidebook page, the method ends 125.

FIG. 3C shows diagram 550 of one embodiment of a method for viewing a recorded audiovisual content event that has an associated Guidebook that is either separate from the content or embedded with the content.

At step 125, the method starts. In the first step it is determined whether the viewer wants to view recorded audiovisual content event with an associated Guidebook 126. If not, the flow moves to step 132. If so, this indicates, in one or more embodiments, that the viewer 20 wants to see information from the associated Guidebook appear while the viewer 20 views the recorded content. At the next step, the system receives a selection of audiovisual content that has an associated Guidebook 128. In one or more embodiments, a viewer 20 will use commands on remote control 22 to scroll through, identify and select a recorded audiovisual content event from a list of recorded content that have associated Guidebooks. In other embodiments, the viewer 20 may use a smart phone 206, tablet 208, or other device and select a recorded content with an associated Guidebook to be displayed on that device. In some instances, this selection may be made via a touch screen interface. The Guidebook associated with the recorded content may be either embedded with the recorded content, or may be associated with it via a link to a Guidebook that may be stored either in the viewer's 20 environment or outside the environment, such as in a database accessible via the Internet.

Once the Guidebook 50 and associated recorded audiovisual content event have been identified, the next step is to display the audiovisual content 130. This content may be displayed on the viewer's 20 display device 24, smart phone 206, tablet 208, or other input/output device 182.

In the next step it is determined if the audiovisual content image being presented has a corresponding image in the Guidebook 132. At this step, the image of the recorded audiovisual content event that is being displayed has a corresponding image in the Guidebook. In some embodiments, this step may be satisfied if the recorded content image is within a threshold number of frames of the corresponding Guidebook page, or within a certain time threshold of the corresponding Guidebook page. If step 132 is satisfied, then display text associated with that Guidebook page is shown on the audiovisual content display 134. There are a number of non-limiting examples of how this may be done, such as overlaying the text on the display device 24 on top of the audiovisual content. In another example, the text is displayed in a portion of the display screen, and the video image is shrunk so that the text does not overlap the audiovisual content presented on the display. In still another example, the audiovisual content is paused, and the text is displayed until the viewer 20 continues the audiovisual content display through selection on remote control 22.

In other embodiments, the Guidebook page information includes information in addition to text, including but not limited to audio files, pictures, graphics, animations, links to URLs at other Internet sites, and the like. At this step the viewer 20 will consume the Guidebook information presented on the display.

At the next step, it is determined whether the viewer wants to view the Guidebook 136. At this step the viewer 20 has the option to open up and “step into” the Guidebook for the associated stored content event and begin to view the Guidebook. If so, then the associated Guidebook 138 is displayed. The method for this step is similar to the method described in FIG. 3. Note: if the viewer 20 wanted to start the audiovisual content viewing process by first looking at its associated Guidebook, the viewer 20 would, in one or more embodiments, use the method described in FIG. 3.

At the next step, it is determined whether there is more audiovisual content to be displayed 140. If so, go the method moves to step 130. Otherwise, the method ends at step 142.

FIG. 4 shows diagram 560 of one embodiment of a computing system for implementing a Guidebook system 58. FIG. 4 includes a computing system 160 that may be utilized to implement Guidebook System (“GBS”) system 58 with features and functions as described above. One or more general-purpose or special-purpose computing systems may be used to implement the GBS system 58. More specifically, the computing system 160 may include one or more distinct computing systems present having distributed locations, such as within a set-top box, or within a personal computing device. In addition, each block shown may represent one or more such blocks as appropriate to a specific embodiment or may be combined with other blocks. Moreover, the various blocks of the GBS system 58 may physically reside on one or more machines, which may use standard inter-process communication mechanisms (e.g., TCP/IP) to communicate with each other. Further, the GBS system 58 may be implemented in software, hardware, firmware or in some combination to achieve the capabilities described herein.

In the embodiment shown, computing system 160 includes a computer memory 162, a display 24, one or more Central Processing Units (“CPU”) 180, input/output devices 182 (e.g., keyboard, mouse, joystick, track pad, LCD display, smart phone display, tablet and the like), other computer-readable media 184 and network connections 186 (e.g., Internet network connections). In other embodiments, some portion of the contents of some or all of the components of the GBS system 58 may be stored on and/or transmitted over other computer-readable media 184 or over network connections 186. The components of the GBS system 58 preferably execute on one or more CPUs 180 and generate content from images and other information put into the system by users or administrators, as described herein. Other code or programs 188 (e.g., a Web server, a database management system, and the like) and potentially one or more other data repository 200, also reside in the computer memory 162, and preferably execute on one or more CPUs 180. Not all of the components in FIG. 4 are required for each implementation. For example, some embodiments embedded in other software do not provide means for user input, for display, for a customer computing system, or other components, such as, for example, a set-top box or other receiving device receiving audiovisual content.

In a typical embodiment, the GBS system 58 includes a content analyzer module 168, a Guidebook creator/editor module 170, and a Guidebook display module 172. Other and/or different modules may be implemented. The GBS system 58 also, in some embodiments, contains the Guidebook library 60 and the Guidebook user preferences database 62.

In addition, the GBS system 58 interacts with communication system 202 with remote control 22, smart phone 206, and tablet 208. In some embodiments, remote control 22 includes Guidebook controls 202 that may be buttons, toggle switches, or other ways to communicate directly with the Guidebook system 58. For example, a set of Guidebook controls 202 may be used to display and scroll through a selection of Guidebooks, play a particular Guidebook, to create a new Guidebook from audiovisual content, to edit the pages in a Guidebook, to store an edited Guidebook, and to edit Guidebook user preferences 62. Guidebook controls 202 also may be used, in some embodiments in conjunction with trick-play controls 204, to view audiovisual content 54 from a selection within a Guidebook 50, and to display information within a Guidebook 50 while the viewer 20 is viewing the audiovisual content 54.

The content analyzer module 168 performs at least some of the functions of analyzing audiovisual content 54 as described with reference to FIGS. 1 and 2. In particular, the content analyzer module 168 interacts with the viewer 20 and other systems to identify the source of the content, for example, an audiovisual content recorded on the set-top box 28 or on a digital video recorder 30. In some cases, the recorded audiovisual content event may be downloaded from a location outside of the viewer's 20 location, such as from a storage location accessible via the Internet over network connections 186. In other examples, the content may be streamed and stored locally, and the content analyzer module 168 may be run while the content is being streamed and stored, or run after all of the content has been received.

The content analyzer module takes information from the Guidebook user preferences database 62 and uses analysis techniques to analyze and to determine those visual, audio and technical cues that indicate when a frame of the audiovisual content should be included as a page in a Guidebook 50 associated with the audiovisual content.

These analysis techniques include image processing techniques to recognize visual characteristics in the content such as movement, changes in background and foreground lighting, identifying objects, and identifying people, as well as recognizing people using, for example, facial recognition techniques. Techniques also include audio analysis, including changes in sound intensity, identifying certain types of sounds including but not limited to gunshots, crowd cheers, whistles, swelling musical scores, and people talking. In addition, voice recognition may be used to determine what character is communicating, and speech recognition may be used to determine what is being said. The above is just a small set of examples of the types of visual and audio analysis that may be performed on the recorded audiovisual analysis to be used to identify key frames in the audiovisual content that, when taken together, will provide a summary of the content to the viewer 20.

The Guidebook creator/editor module 170 performs at least some of the functions of allowing a viewer 20, for example, to specify a recorded audiovisual content event to have a Guidebook dynamically created from it as well as allowing the viewer 20 to edit a Guidebook 50 using remote control 22. Using the functions of Guidebook creation and editing as described above in FIGS. 1, 2 and 3A. The Guidebook creator/editor module 170 takes as input the recorded audiovisual content event along with the output of the content analyzer module 168 to dynamically identify those key frames that can be used to summarize the audiovisual content, and then use the images associated with those frames to create the Guidebook for that content.

The Guidebook creator/editor module 170 also allows a viewer 20 to add pages to the Guidebook that were not added dynamically, as well as to remove those pages in the Guidebook that the user wants to remove. As discuss above, this can be accomplished, in one or more embodiments, by using a remote control 22, or by using other input/output devices 182 to select pages to add or remove.

In one or more embodiments, the Guidebook creator/editor module 170 includes the ability to add additional information to a Guidebook page. For example, text information may describe the action shown at that page, give a list of characters on that page, give plot information at that point in the movie, or give the score at that point of the game. In addition to text, Guidebook page information may include additional information such as, but not limited to, audio files, pictures, graphics, animations, links to URLs at other Internet sites, and the like.

In some embodiments, this text and additional information displayed on a Guidebook page may be added by the Guidebook creator/editor module 170, or added by the viewer 20 by editing the Guidebook page, for example, by using remote control 22.

The Guidebook display module 172 performs at least some of the functions as described in FIGS. 1, 4B and 4C. In one or more embodiments, this module will display the Guidebook to a viewer 20 on a display device 24 to allow the viewer to determine whether to watch all, part or none of the recorded audiovisual content event associated with the Guidebook. In some embodiments, the pages in the Guidebook may be viewed as either a spread of pages that the viewer 20 can review, or as a sequence of pages the viewer 20 can step through in order to understand the story or plot of the associated audiovisual content.

In other embodiments, the Guidebook display module 172 will allow the viewer to begin viewing the recorded audiovisual content event at the point designated by a particular Guidebook page. In still other embodiments, the module will display information included in a Guidebook page, while the viewer 20 is watching the audiovisual content, when the audiovisual content is within a threshold number of frames of the corresponding Guidebook page, or within a certain time threshold of the corresponding Guidebook page.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method, comprising:
receiving, by a computing system, a plurality of video frames from an audiovisual content event;
recording, by the computer system, the plurality of video frames from the audiovisual content event as recorded audiovisual content;
determining, by the computing system, multiple video frames of the plurality of video frames that include images that provide a visual summary of the audiovisual content event;
associating, by the computing system, each of the multiple video frames with its respective time location in the audiovisual content event;
storing, by the computing system, each of the multiple video frames and each respective time location in a respective one of a plurality of pages of a guidebook that enables viewing of a summary of the audiovisual content event;
determining whether the guidebook is to be embedded into the recorded audiovisual content; and
in response to determining that the guidebook is to be embedded into the recorded audiovisual content, embedding the guidebook into the recorded audiovisual content.

2. The method of claim 1, comprising:
causing, by the computing system, the plurality of video frames from the audiovisual content event to be displayed on a display device;
receiving, by the computing system, a command to add a video frame that is currently displayed by the display device to the guidebook data; and
in response to receiving the command, adding the video frame that is currently displayed by the display device to one of the pages of the guidebook.

3. The method of claim 1 wherein the determining of the multiple video frames further comprises:
receiving additional audiovisual content information; and
identifying a frame based on the content information.

4. The method of claim 1 wherein the determining of the multiple video frames further comprises identifying a frame when a majority of pixels change from the previous frame.

5. The method of claim 1 wherein the determining of the multiple video frames further comprises:
applying visual analysis techniques to the image in the frame.

6. The method of claim 5 wherein the determining of the multiple video frames further comprises:
identifying, based on the applied visual analysis techniques, a frame where a person depicted in the frame makes a particular hand gesture.

7. The method of claim 5 wherein the determining of the multiple video frames further comprises:
identifying, based on the applied visual analysis techniques, a frame when a selected person first appears in the audiovisual content event.

8. The method of claim 5 wherein the determining of the multiple video frames further comprises:
identifying, based on the applied visual analysis techniques, a frame when a numerical score of a sporting event depicted in the frame changes from the previous frame.

9. The method of claim 1 wherein the determining of the multiple video frames further comprises:
applying audio analysis techniques to the frame.

10. The method of claim 9 wherein determining of the multiple video frames further comprises:
identifying, based on the applied audio analysis techniques, a frame where a gunshot has just sounded.

11. The method of claim 9 wherein determining of the multiple video frames further comprises:
identifying, based on the applied audio analysis techniques, a frame where a particular word has just been spoken.

12. The method of claim 1, further comprising, after the storing of the indications of the multiple video frames:
including, in the stored indications of the multiple video frames, additional content related to the respective time location in the audiovisual content event.

13. The method of claim 12, further comprising:
displaying the audiovisual content event on the display device;
in response to displaying video frames from the displayed audiovisual content that is within a threshold number of frames from an associated one of the multiple video frames including additional content, displaying the additional content along with the video frames from the audiovisual content event on the display device.

14. A system, comprising:
a display; and
a content receiver connected to-a the display, the receiver including:
a processor; and
a non-transitory computer-readable memory communicatively coupled to the processor, the memory having computer-executable instructions stored on the memory that cause the processor to:
receive an audiovisual content event;
record the plurality of video frames from the audiovisual content event as recorded audiovisual content;
analyze the audiovisual content event to determine frames within the content event that indicate transition events; and
store each of the determined frames in a respective one of a plurality of pages of a guidebook, in the memory;
determine whether the guidebook is to be embedded into the recorded audiovisual content; and
in response to determining that the guidebook is to be embedded into the recorded audiovisual content, embed the guidebook into the recorded audiovisual content.

15. The system of claim 14 wherein the content receiver is a set-top box.

16. The system of claim 14 wherein the computer-executable instructions cause the processor to:
receive, from a Guidebook user preferences database, information personal to the user to be used to determine a transition event.

17. The system of claim 14, wherein, after the computer-executable instructions cause the processor to store each of the determined frames as one of the plurality of pages of the guidebook in the memory, the computer-executable instructions cause the processor to:
retrieve the determined frames from the memory;
present the determined frames to a user;
in response to an editing command received from the user, edit the determined frames; and
store the edited determined frames in the memory.

18. The system of claim 17 wherein the editing command received from the user further comprises a command received from a set-top box remote-control.

19. A non-transitory computer-readable storage medium having stored contents that configure a computing system to perform a method, the method comprising:
receiving, by a computing system, a plurality of video frames from an audiovisual content event;
recording, by the computer system, the plurality of video frames from the audiovisual content event as recorded audiovisual content;
determining, by the computing system, multiple video frames of the plurality of video frames that include images that provide a visual summary of the audiovisual content event;
associating, by the computing system, each of the multiple video frames with its respective time location in the audiovisual content event;
storing, by the computing system, each of the multiple video frames and each respective time location in a respective one of a plurality of pages of a guidebook that enables viewing of a summary of the audiovisual content event;
determining whether the guidebook is to be embedded into the recorded audiovisual content; and
in response to determining that the guidebook is to be embedded into the recorded audiovisual content, embedding the guidebook into the recorded audiovisual content.

20. The non-transitory computer-readable storage medium of claim 19 wherein the recorded audiovisual content is located on a digital video recorder.

21. The computer-implemented method of claim 1, wherein associating each of the multiple video frames with its respective time location further includes associating each of the multiple video frames with a respective description of video frames.

22. The system of claim 1, wherein the computer-executable instructions cause the processor to store the guidebook in a storage device.
